(19) United States
(12) Patent Application Publication
(10) Pub. No.: US 2025/0030677 A1
(43) Pub. Date: Jan. 23, 2025

(54) CENTRALIZED MANAGEMENT UNIT OF AUTHORIZATION PROTOCOL IN uSERVICES ARCHITECTURE

(71) Applicant: DevRev, Inc., Palo Alto, CA (US)

(72) Inventors: Peter Marinšek, Ljubljana (SI); Mladen Barjaktarevic, Ljubljana (SI)

(73) Assignee: DevRev, Inc., Palo Alto, CA (US)

(21) Appl. No.: 18/354,540

(22) Filed: Jul. 18, 2023

(51) Int. Cl. H04L 9/40

(52) U.S. Cl. CPC H04L 63/083

(57) ABSTRACT

A centralized management unit for authorization framework like OAuth 2.0 service is built rather than using distributed approach. The present centralized management unit for Authorization framework provides access tokens to all other uServices for accessing user data outside of the internal security domain. This approach greatly simplifies integrations with third-party services, as all uServices need just to obtain a suitable access token from the centralized authorization framework. The present centralized Authorization framework service facilitate protocol implementation, internal authorization, handling of the access tokens, revoking of access tokens, and most important, handling of third-party services tokens validity and refresh token procedure.

### FIELD OF THE INVENTION

The subject matter of the present invention relates to authorization framework more specifically to a centralized controller which enables a third-party application to obtain limited access to an API of other applications, devices, and servers on the user's behalf without the need to provide the user's credentials every time for each granted access to such external party applications.

### BACKGROUND OF THE INVENTION

The conventional authorization framework like OAuth 2.0 in today's SaaS world has become a byword for authorization. OAuth is an open-standard authorization protocol/framework that enables applications to gain limited access to user accounts of another application without sharing a password. These applications are provided with an authorization token that can be used for using services of another application on the user's behalf without compromising the user's password. OAuth can be used to authorize applications, APIs, devices, and servers.

Due to the high adoption rate of the authorization framework like the OAuth 2.0 standard, there are many open sources, ready-to-use client libraries, like the oauth2 go package or jso javascript library. These client libraries are very sophisticated and advanced. Most of them are implemented with a great deal of flexibility and configurability to support various use cases. Many public cloud services like GitHub, AWS, or similar SaaS solutions are deeply entrenched in the fundamental infrastructure of every IT company nowadays. Most of these services offer almost unlimited access to user data via publicly available API, protected by OAuth 2.0 protocol authorization. Unfortunately, there are a lot of implementational details, i.e. differences between OAuth 2.0 protocol implementations among these public services. For example, many solutions expect one to have OAuth 2.0 application installed in the “organization”. Such applications define access level to API which is segmented across security “groups”. Users would have to confirm awareness of the level of API access such an application gets after approval. Other services took a bit different approach and offer both applications (active plugins) and passive OAuth 2.0 applications access to the user data. The level of access to applications can vary between services. In the increasingly connected world, the main aim of the SaaS application is not to displace competitors but, on the contrary, to connect to as many as possible third-party applications. This approach allows users to combine various services (and respective value proposals) into a single unique customer experience just by combining various services. Thus, the user usually can continue using existing services and enable additional services without typical nuisances like data migration, account migrations, creating new groups, and defining new access levels. Instead, the user has just to allow (enable) new service to access the existing data in third-party services. The exchange of data in this scenario can flow in both directions, from the old service to the new service and vice versa. Almost without exception, a new SaaS service is usually a set of number of uServices. Every uService has its own narrowly defined role. To implement a flow, user journey, or data analytics solutions in a new SaaS service, typically a significant number of uServices are required. Each of these uServices must have access to the third-party services via third-party API protected by OAuth 2.0 protocol. The conventional way of solving this challenge was using common secret storage (secrets vault) which is accessed by all uServices. Secrets vault would contain user credentials for third-party services. uService, when needs data from a third-party service, would use user credentials from the vault and obtain OAuth 2.0 access token using OAuth 2.0 protocol, fetch the required data, and discard obtained access token. In this scenario, every uService must include an OAuth protocol library, and care about access tokens, refresh, errors, secure handling of the customer secrets, etc. This overhead impacts the speed of uService implementation and the overall complexity and security of the system.

There is a need for an alternate approach where instead of distributing OAuth 2.0 protocol implementations to each uService, implementing a single service which would encapsulate all details of OAuth 2.0 protocol as well as handle all corner cases, individual third-party services implementation details, access token refresh logic, tokens revocations logic, secure storage, and token scope mechanism.

### SUMMARY OF THE INVENTION

One or more implementations of the present specification provide a centralized management unit for an authorization framework. To achieve the objective above, one or more implementations of the present specification provide the following technical solutions:

In accordance with one or more implementations of the present specification, a centralized management unit for authorization framework like OAuth 2.0 service is built rather than using a distributed approach. The present centralized management unit for authorization framework service provides access tokens to all other uServices that need to access user data outside of the internal security domain. This approach greatly simplifies integrations with third-party services, as all uServices need just to obtain a suitable access token from the centralized authorization framework. The present centralized authorization framework cares about protocol implementation, internal authorization, handling of the access tokens, revoking of access tokens, and most important, handling of third-party services tokens validity and refresh token procedure. It also abstracts all OAuth 2.0 implementation details, thus allowing the uService developers to focus solely on the uService main role.

In an aspect of one or more implementations of the present specification, the centralized management unit of the authorization framework enables a third-party application to obtain limited access to an API service or external devices or servers, either on behalf of a resource owner by organizing an approval interaction between the resource owner and the API service, or by allowing the third-party application to obtain access on its behalf. There are four actors, also referred to as roles, in an OAuth flow. The resource Owner (User) is the owner of the respective data that resides on the resource server. The resource owner authorizes the account access which is limited to the scope of granted authorization. Resource Server (API) is where the user account/resources are hosted in a protected environment. Client (third-party Application) is the application that requests access to the user account. The authorization Server (API) is the authorization server that performs the identity verification to issue the access token. These actors interact with each other based on the OAuth protocol.

The general flow of an OAuth protocol comprises steps: The client wants to access the resource server and asks for permission from the user. The user either authorizes the request or denies it. In the event of authorization, the client gets an authorization grant. The client, then, presents this authorization grant and his identity to the authorization server and requests an access token. If the client has both, a valid identity and an authorization grant, the authorization server provides it with an access token. The client, then, goes to the resource server and requests the resource access by presenting the access token to it. The resource server provides permitted limited access to the client only if the token is valid.

In another aspect of the present specification, the centralized management unit generates an access token and stores such tokens in a vault. The generation of access tokens and management of such access tokens in a centralized framework rather than in a distributed framework reduces the monitoring and management stress of the authorization framework. The scope of the access token is defined, and the scope is monitored by the centralized management unit of the authorization protocol.

In another aspect of the present specification, the centralized management unit comprises a token management module that performs, defining token scope, validating the token, refreshing the token if the token is expired, and revoking or invalidation of a token. The tokens are stored in a repository called a token vault.

In another aspect, when a third-party application like uService requests an access token the centralized management unit verifies two conditions: whether the user has such privilege to request an access token and whether such service has access to any tokens. If these conditions are satisfied, then the token scope is validated and if the token is active then an access token is provided to the third-party application.

In another aspect, the access token is validated by requesting the API of the service, and the scope of the token is validated if the token is valid then access is granted else a request for a refresh token is initiated, and refreshing the token involves an additional authorization protocol handshake with the external service.

It is noted that the term “service”, “microservice”, or “uservice” may be used in conjunction with specific embodiments, but the techniques described herein are applicable to any type of service or microservice, and are not to be limited to either service or microservice in particular unless expressly claimed as such.

Other objects, aspects, features, and goals of the present invention will be better understood from the following detailed description. The following description is illustrative and is not intended to be in any way limiting. In addition to the illustrative aspects, embodiments, and features described above, further aspects, embodiments, and features will become apparent by reference to the following detailed description.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the embodiments taken in conjunction with the accompanying drawings wherein reference letters and numerals indicate the corresponding parts in various figures in the accompanying drawings, and in which:

FIG. 1 illustrates a schematic block diagram of the centralized management unit of the authorization framework in accordance with an embodiment of the present specification.

FIG. 2 illustrates a process flow of granting access tokens in accordance with an embodiment of the present specification.

FIG. 3 illustrates a schematic block diagram of the token management module of the centralized management unit of the authorization framework in accordance with an embodiment of the present specification.

FIG. 4 illustrates a process flow of validating and granting access tokens to third-party applications in accordance with an embodiment of the present specification.

FIG. 5 illustrates a process flow of validating tokens through the API of the third-party application in accordance with an embodiment of the present specification.

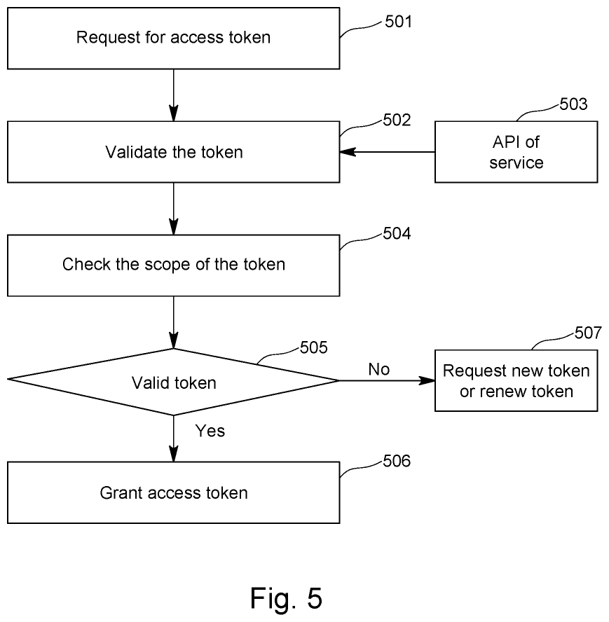

FIG. 6 illustrates a process flow of refreshing or renewal of tokens in accordance with an embodiment of the present specification.

FIG. 7 illustrates a process flow of invalidation of tokens in accordance with an embodiment of the present specification.

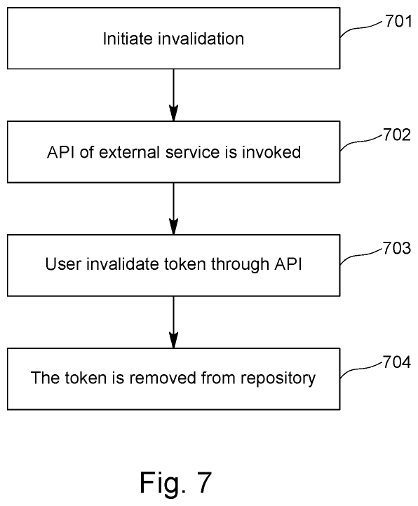

FIG. 8 is a block diagram of an illustrative computing system suitable for implementing an embodiment of the present invention.

### DETAILED DESCRIPTION OF THE PREFERRED AND/OR ILLUSTRATED EMBODIMENTS OF THE PRESENT INVENTION

Example implementations are described in detail here, and examples of the example implementations are presented in the accompanying drawings. When the following description relates to the accompanying drawings, unless specified otherwise, the same numbers in different accompanying drawings represent the same or similar elements. The implementations described in the following example implementations do not represent all implementations that are consistent with one or more implementations of the present specification. On the contrary, the implementations are only examples of apparatuses and methods that are described in the appended claims in detail and consistent with some aspects of one or more implementations of the present specification.

It is worthwhile to further note that the term “includes”, “contain”, or any other variant is intended to cover a non-exclusive inclusion, so that a process, a method, merchandise, or a device that includes a list of elements not only includes those elements but also includes other elements which are not expressly listed, or further includes elements inherent to such process, method, merchandise, or device. An element preceded by “includes a . . . ” does not, without more constraints, preclude the existence of additional identical elements in the process, method, merchandise, or device that includes the element.

The terms used in one or more implementations of the present specification are merely used to describe specific implementations and are not intended to limit one or more of the implementations of the present specification. The terms “a”, “said”, and “the” of singular forms used in the present specification and the appended claims are also intended to include plural forms unless otherwise specified in the context. It should also be understood that the term “and/or” used in the present specification indicates and includes any or all possible combinations of one or more associated listed items.

The present specification is related to a centralized management unit for authorization frameworks like OAuth 2.0 service. The present centralized management unit for authorization framework provides access tokens to all other uServices that need to access user data outside of the internal security domain. This approach greatly simplifies integrations with third-party services, as all uServices need just to obtain a suitable access token from the centralized authorization framework. In one of the embodiments, the centralized management unit facilitates protocol implementation, internal authorization, handling of the access tokens, revoking of access tokens, validating third-party services tokens, and refreshing a token.

In the current embodiment, the centralized management comprises an authorization module to perform the authorization process; an adaptation layer to unify the user experience for third-party applications; and a token management module. The centralized management unit of claim facilitates the pairing of a matching authorization algorithm with the external authorization service through the adaptation layer. The token management module defines the token scope, validates the token, refreshes the token if the token is expired, and revokes or invalidates the token.

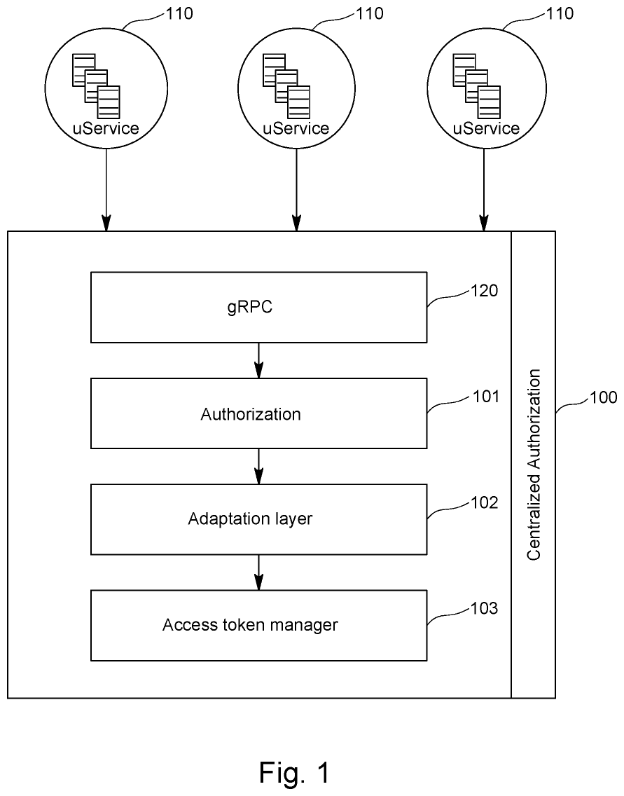

In the embodiment, the centralized management unit generates an access token and stores such tokens in a vault. The generation of access tokens and management of such access tokens in a centralized framework rather than in a distributed framework reduces the monitoring and management stress of the authorization framework. The scope of the access token is defined, and the scope is monitored by the centralized management unit of the authorization protocol. FIG. 1 is the schematic block representation of the centralized management unit 100 of the authorization framework which comprises an authorization module 101 to perform an authorization process that is initiated by the user which is previously authenticated to the present authorization framework. This is an important prerequisite to later link the access token to the user. The user selects an external OAuth service to be authorized for (ex. Slack, Google, etc.). Based on the selection, the centralized management unit 100 pairs a matching OAuth authorization algorithm through the adaptation layer 102 to unify the user experience through all external OAuth services. The centralized management unit 100 then continues with the OAuth 2.0 handshake protocol where in the final step it receives the access token, its expiration date, and optionally (if supported by the external service) the refresh token as well from the token management module 103. The present architecture 100 enables faster integration of OAuth 2.0-based protocols in uServices 110.

The present authorization framework implements gRPC framework 120. gRPC is a high-performance remote procedure call framework released by Google and can be implemented across both open-source and enterprise communities to accommodate the client-server interactions needed for things like cross-platform development and microservice architecture design. gRPC can simplify the process for developers to build connected systems by connecting services in and across data centers. It also provides pluggable support for tracing, health checking, load balancing, and authentication.

An OAuth Access Token is a string that the OAuth client (third-party application 110) uses to make requests to the resource server. The access tokens do not have to be in any format, and practice, various OAuth servers have chosen many different formats for their access tokens. Access tokens may be either “bearer tokens” or “sender-constrained” tokens. Sender-constrained tokens require the OAuth client to prove possession of a private key in some way to use the access token, such that the access token by itself would not be usable. Access tokens must not be read or interpreted by the OAuth client. The OAuth client is not the intended audience of the token. Access tokens do not convey user identity or any other information about the user to the OAuth client. Access tokens should only be used to make requests to the resource server.

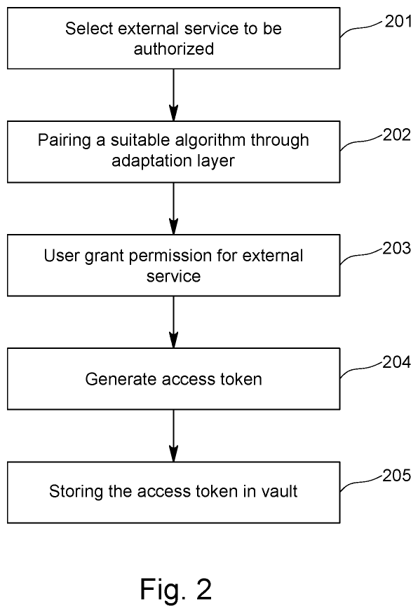

FIG. 2 is the process flow of granting access tokens in accordance with the current embodiment of the present specification. The authorization processes comprising selecting an external authorization service to be authorized 201 by the user; pairing a matching authorization algorithm 202 with the selected external authorization service through the adaptation layer; redirecting the user to the web page of the external authorization service and the user is allowed to accept the terms and conditions for authorization 203; if the user agrees and accepts the terms, redirecting back to present authorization framework and the centralized management unit continues with the authorization handshake protocol; receiving the access token 204 along with the scope definition comprising its expiration date and optionally (if supported by the external service) the refresh token as well; and storing the access token 205, its expiration date and the refresh token into a secure vault and informing the user about the result.

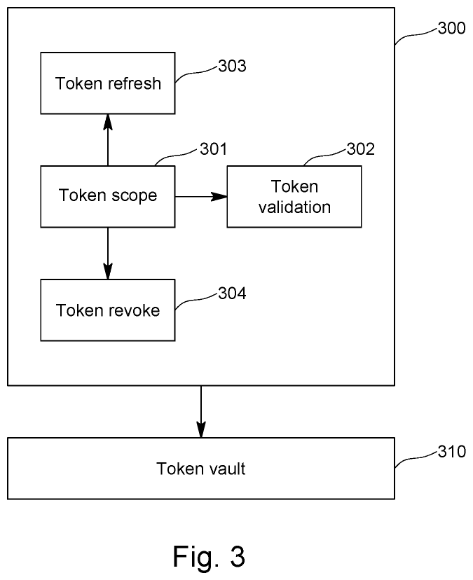

In accordance with the embodiment, as shown in FIG. 3, the centralized management unit comprises a token management module 300 which performs, defining token scope 301, validating the token 302, refreshing the token if the token is expired 303, and revoking or invalidation of a token 304. The tokens are stored in a repository called token vault 310.

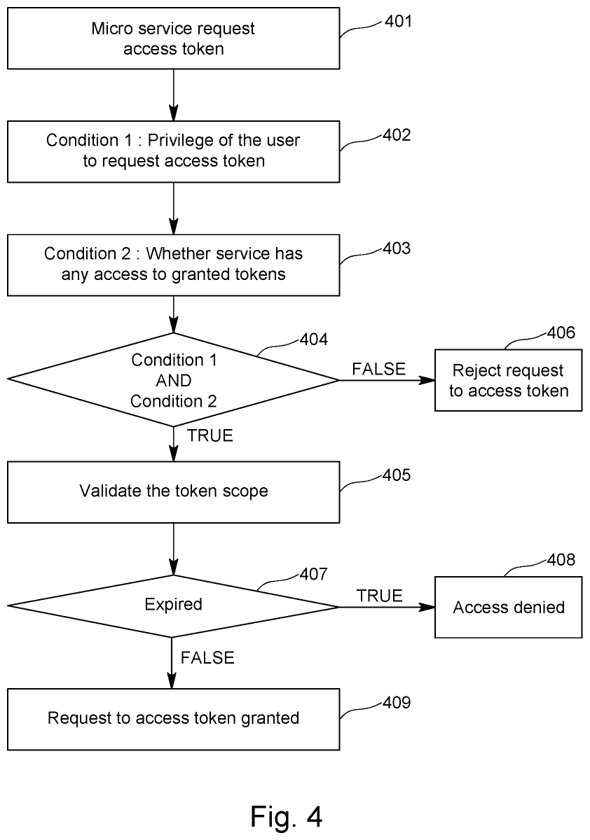

In FIG. 4 a process flow of validating and granting access tokens to third-party applications in accordance with an embodiment is specified. When a third-party application like uService requests access token 401, the centralized management unit verifies two conditions: whether the user has such privilege to request access token 402 and whether such service has access to any token 403. If these conditions are satisfied 404, then the token scope is validated 405. If both conditions are not satisfied, then the request for an access token is rejected 406. While validating the token 405 if the token is active then the access token is provided 408 to the third-party application. If the token is expired or invalidated by user 407, then access to the token is denied 409 by the centralized management unit of the authorization framework of the present specification. The privilege of the user is defined by the user credentials and the user preferences relative to the terms and conditions for data usage. These terms and conditions of data usage defined by the user must fall within the scope of the working terms and conditions of the third-party applications.

When the microservice requests access token 501, the access token is validated 502 by requesting the API 503 of the service, and the scope of the token 504 (whether invalidated token or not) is validated if the scope of the token is valid 505 then access is granted 506 else a request for a refresh token is initiated 507 and refreshing the token involves an additional authorization protocol handshake with the external service.

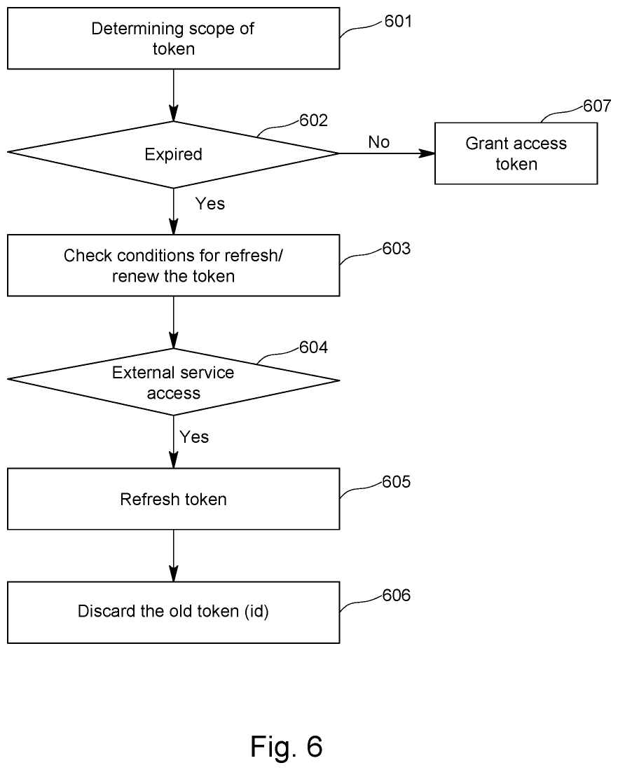

In accordance with the current embodiment the present centralized management unit for authorization framework autonomously refreshes access tokens as long as at least a single service needs it, ensures the destruction of access tokens when they are not needed, and ensures that only authorized uServices get access to the third-party services access tokens. Validation of the scope of the token is illustrated in the process flow as shown in FIG. 6. The scope of the access token is determined 601 by verifying the term of the token and whether it is active or invalidated by the user. If the token is expired 602, then terms for renewal or refreshing the token are verified 603, and refreshing the token involves an additional authorization protocol handshake with the external service 604, and if the user grants all the required permission on the API of the external service, then the token is refreshed 605 and the old token is discarded 606.

An OAuth Refresh Token is a string that the OAuth client can use to get a new access token without the user's interaction. A refresh token must not allow the client to gain any access beyond the scope of the original grant. The refresh token exists to enable authorization servers to use short lifetimes for access tokens without needing to involve the user when the token expires.

The user can invalidate a token at any time and such invalidation comprises steps of initiating invalidation 701; invoking external service API 702; the user invalidating the token 703 by disallowing all the granted licenses and permissions for using the user data for authorization; removing or erasing 704 the invalidated token from the token vault or repository.

The present approach of centralized management of authorization frameworks like the OAuth 2.0 protocol also encapsulates the potential protocol changes that might happen in the future. For example, once OAuth 2.1 protocol gets enough adoption, it must be implemented only in the present centralized management unit of the OAuth 2.0 protocol. All other uServices would continue to operate against the access token, without any change in the code or operation procedures. The centralized management unit of the OAuth 2.0 protocol also enables more generic extensions, by adding support for the centralized handling of PAT tokens, and uServices secrets.

In another embodiment, a method for authorization for a centralized authorization framework, such method comprising performing an authorization process that is initiated by the user through third-party applications; pairing a matching authorization algorithm with the third-party application and the centralized authorization framework through the adaptation layer; and defining and generating access token through token management mod

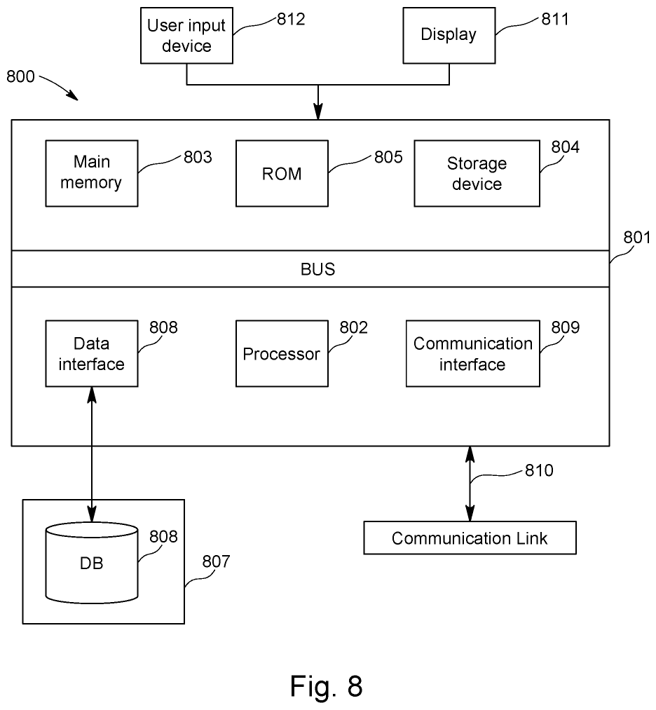

FIG. 8 is a block diagram of an illustrative computing processing system 800 suitable for implementing an embodiment of the present invention. The computer processing system 800 comprises a processing unit; a communications interface; and a non-transitory computer-readable storage medium to store instructions, wherein the processing unit executes the stored instructions to perform protocol implementation, internal authorization, handling of the access tokens, revoking of access tokens, validating third-party services tokens, and refreshing a token.

Computer processing system 800 includes a bus 801 or another communication mechanism for communicating information, which interconnects subsystems and devices, such as processor 802, system memory 803 (e.g., RAM), static storage device 804 (e.g., ROM), disk drive 805 (e.g., magnetic, or optical), communication interface 809 (e.g., modem or Ethernet card), display 811 (e.g., CRT or LCD), input device 812 (e.g., keyboard), and cursor control.

According to one embodiment of the invention, computer processing system 800 performs specific operations by processor 802 executing one or more sequences of one or more instructions contained in system memory 803. Such instructions may be read into system memory 803 from another computer-readable/usable medium, such as static storage device 804 or disk drive 805. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer-readable medium” or “computer-usable medium” as used herein refers to any medium that participates in providing instructions to processor 802 for execution. Such a medium may take many forms, including but not limited to, non-volatile media and volatile media. Non-volatile media includes, for example, optical or magnetic disks, such as disk drive 805. Volatile media includes dynamic memory, such as system memory 803. A database 808 may be accessed in a computer-readable medium 807 using a data interface 806.

Common forms of computer-readable media include, for example, floppy disk, a flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip, or cartridge, or any other medium from which a computer can read.

In an embodiment of the invention, execution of the sequences of instructions to practice the invention is performed by a single computer processing system 800. According to other embodiments of the invention, two or more computer systems 800 coupled by communication link 810 (e.g., LAN, PTSN, or wireless network) may perform the sequence of instructions required to practice the invention in coordination with one another.

Computer processing system 800 may transmit and receive messages, data, and instructions, including program, i.e., application code, through communication link 810 and communication interface 809. Received program code may be executed by processor 802 as it is received, and/or stored in disk drive 805, or other non-volatile storage for later execution.

In a typical configuration, the computer includes one or more processors (CPU), an input/output interface, a network interface, and a memory. The memory can include a non-persistent memory, a random-access memory (RAM), and/or a nonvolatile memory in a computer-readable medium, for example, a read-only memory (ROM) or a flash memory (flash RAM). Memory is an example of a computer-readable medium.

Features described as separate implementations may be implemented, in combination, in a single implementation, while features described as a single implementation may be implemented in multiple implementations, separately, or in any suitable sub-combination. Operations or processes or methods described and claimed in a particular order should not be understood as requiring that the particular order, nor that all illustrated operations must be performed (some operations can be optional). As appropriate, multitasking or parallel processing (or a combination of multitasking and parallel-processing) can be performed.

Specific implementations of the present specification are described above. Other implementations fall within the scope of the appended claims. In some situations, the actions or steps described in the claims can be performed in an order different from the order in the implementations and the desired results can still be achieved. In addition, the process described in the accompanying drawings does not necessarily need a particular execution order to achieve the desired results. In some implementations, multitasking and parallel processing can be advantageous.

The descriptions above are only example implementations of the one or more implementations of the present specification but are not intended to limit one or more implementations of the present specification. Any modification, equivalent replacement, improvement, etc. made without departing from the scope and principle of the one or more implementations of the present specification shall fall within the protection scope of the one or more implementations of the present specification.

What is claimed is:

1. A centralized management unit of an authorization framework comprising: an authorization module to perform authorization process; an adaptation layer to unify user experience for third-party applications; and a token management module.

2. The centralized management unit of claim 1, which facilitates pairing of a matching authorization algorithm with an external authorization service through the adaptation layer.

3. The centralized management unit of claim 1, wherein the authorization module performs a authorization process that is initiated by a user which is previously authenticated to the authorization framework.

4. The centralized management unit of claim 1, wherein the token management module defines token scope, validates the token, refreshes token if token is expired and revokes or invalidates the token.

5. The centralized management unit of claim 4, wherein the token management module verifies two conditions: whether a user has privilege to request access token and whether a service has access to any tokens to validate the scope of the token.

6. A method for authorization for a centralized authorization framework, comprising: performing an authorization process that is initiated by a user through third-party applications; pairing a matching authorization algorithm with the third-party application and the centralized authorization framework through an adaptation layer; and defining and generating an access token through a token management module.

7. The method of claim 6, wherein the authorization process comprises selecting an external authorization service to be authorized by the user; pairing a matching authorization algorithm with the selected external authorization service though the adaptation layer; redirecting the user to a web page of the external authorization service and the user is allowed to accept terms and conditions for authorization; if the user agrees and accepts the terms, redirecting back to present authorization framework and centralized management unit continues with an authorization handshake protocol; receiving the access token along with a scope definition comprising its expiration date and optionally provide refresh token as well; and storing the access token, its expiration date and the refresh token into a secure vault and informing the user about a result.

8. The method of claim 6, further comprising defining token scope, validating the token, refreshing the token if the token is expired and revoking or invalidation of the token.

9. The method of claim 8, wherein validating the token comprising requesting access token by the third-party application; verifying two conditions: whether the user has such privilege to request access token and whether such service has access to any tokens; validating the scope of the token if these conditions are satisfied; rejecting the request for access token if these conditions are not satisfied.

10. The method of claim 8, wherein validating the token further comprising validating scope of the token; if the scope is active then access token is granted and if the scope is expired or invalidated by the user then initiating request for refreshing the access token or denying a request of access token.

11. The method of claim 8, wherein validating the token comprising requesting access token by the third-party application; validating the access token by requesting the API of the service: verifying the scope of the token (whether invalidated token or not); if the scope of token is valid then access is granted else initiating a request for a refresh token.

12. The method of claim 8, wherein the refreshing the token comprises requesting an additional authorization protocol handshake with an external service; allowing the user to grant a required permission on the API of the external service; refreshing the token and discarding an old token from a token vault.

13. The method of claim 8, wherein the invalidating of the token comprises initiating invalidation; invoking external service API; invalidating the token by disallowing granted licenses and permissions for using user data by the user; removing or erasing the invalidated token from the token vault or repository.

14. A computer processing system comprises a processing unit; a communications interface; and a non-transitory computer-readable storage medium to store instructions, wherein the processing unit execute the stored instructions to perform protocol implementation, internal authorization, handling of access tokens, revoking of the access tokens, validating third-party services tokens, and refreshing a token.

15. A computer readable medium storing a set of instructions that when executed, cause a processing module of a computer to perform: an authorization process that is initiated by a user through third-party applications; pairing a matching authorization algorithm with the third-party application and a centralized authorization framework through an adaptation layer; and defining and generating an access token through a token management module.

16. The computer readable medium of claim 15, wherein a set of instructions that when executed, cause the processing module to perform authorization process comprising: selecting an external authorization service to be authorized by the user; pairing a matching authorization algorithm with the selected external authorization service though the adaptation layer; redirecting the user to a web page of the external authorization service and the user is allowed to accept terms and conditions for authorization; if the user agrees and accepts the terms, redirecting back to present authorization framework and a centralized management unit continues with an authorization handshake protocol; receiving the access token along with a scope definition comprising its expiration date and optionally provide refresh token as well; and storing the access token, its expiration date and the refresh token into a secure vault and informing the user about a result.

17. The computer readable medium of claim 15, wherein a set of instructions that when executed, cause the processing module to perform: defining token scope, validating the token, refreshing the token if the token is expired and revoking or invalidation of the token.

18. The computer readable medium of claim 17, wherein a set of instructions that when executed, cause the processing module to perform validation of the token that further comprising: requesting access token by the third-party application; verifying two conditions whether the user has such privilege to request access token and whether such service has access to any tokens; validating the scope of the token if these conditions are satisfied; rejecting the request for access token if these conditions are not satisfied.

19. The computer readable medium of claim 17, wherein a set of instructions that when executed, cause the processing module to perform validation of the token that further comprising: validating scope of token; if the scope is active then access token is granted and if the scope is expired or invalidated by the user then initiating request for refreshing the access token or denying a request of access token.

20. The computer readable medium of claim 17, wherein a set of instructions that when executed, cause the processing module to perform validation of the token that further comprising: requesting access token by the third-party application; validating the access token by requesting the API of the service; verifying the scope of the token (whether invalidated token or not); if the scope of token is valid then access is granted else initiating a request for a refresh token.

21. The computer readable medium of claim 17, wherein a set of instructions that when executed, cause the processing module to perform refreshing the token that further comprising: requesting an additional authorization protocol handshake with an external service; allowing the user to grant a required permission on the API of the external service; refreshing the token and discarding an old token from a token vault.

22. The computer readable medium of claim 17, wherein a set of instructions that when executed, cause the processing module to perform invalidation of the token that further comprising: initiating invalidation; invoking external service API; invalidating the token by disallowing granted licenses and permissions for using user data by the user; removing or erasing the invalidated token from the token vault or repository.

23. A centralized management unit for an authorization framework to provide access tokens to third-party services for accessing user data outside of an internal security domain, wherein the centralized management unit facilitates protocol implementation, internal authorization, handling of the access tokens, revoking of access tokens, validating third-party services tokens, and refreshing a token.

24. The centralized management unit of claim 23 that further comprises: an authorization module to perform an authorization process; an adaptation layer to unify user experience for third-party applications; and a token management module.

25. The centralized management unit of claim 24, which facilitates pairing of a matching authorization algorithm with an external authorization service through the adaptation layer.

26. The centralized management unit of claim 23, wherein an authorization module performs an authorization process that is initiated by a user which is previously authenticated to the authorization framework.

27. The centralized management unit of claim 23, wherein a token management module defines token scope, validates the token, refreshes token if token is expired and revokes or invalidates the token.
